(19) United States
(12) Patent Application Publication
(10) Pub. No.: US 2009/0228654 A1
(43) Pub. Date: Sep. 10, 2009

(54) Media Cartridge Resident Auto-Sensing/Loading Archive Software

(75) Inventor: Michael Lakowicz, Concord, NH (US)

Correspondence Address: BAKER BOTTS L.L.P., 2001 ROSS AVENUE, SUITE 600, DALLAS, TX, 75201-2980, US

(73) Assignee: Quantum Corporation, a Delaware Corporation

(21) Appl. No.: 12/043,873

(22) Filed: Mar. 6, 2008

(51) Int. Cl. G06F 12/00; G11B 5/016; G06F 13/00

(52) U.S. Cl. 711/115; 360/99.06; 711/161

(57) ABSTRACT

The present invention, in particular embodiments, provides methods, apparatuses and systems directed to a removable cartridge which has a data storage device, such as a hard drive, that contains a data archive application and a loader or installer. In one implementation, the data storage device contains platform-independent archive data, and one or more differing platform-dependent archive applications. When the removable cartridge is connected to a host with no installed archive application, an archive application on the removable cartridge, corresponding to the host operating system, may be installed. Archive data is then translated to a format compatible with the host operating system and provided to the host.

### TECHNICAL FIELD

The present disclosure generally relates to a cartridge-based data storage device that includes a hard disk drive and, more particularly, to a data storage device in which the hard disk drive is removable from a carrier installed in a host computing system.

### BACKGROUND

As the value and use of information increases, individuals and businesses seek additional ways to process and store information. One aspect of this evolution has been a progressively growing demand for increased storage capacity in portable memory devices. With the advent of personal computers and workstations, it is often desirable or necessary to remove the medium on which digital data is stored. A user may desire to remove a storage medium to carry it to a different site and/or a different computer system. It may also be desirable to remove the storage medium to a secure location when the stored computer data is sensitive, secret, or a back-up copy is needed. One option is the use of hard disk drives contained in removable cartridges.

Removable hard disk drives are typically housed in a larger shell or cartridge having isolating materials to protect the hard disk drive from dirt or other contaminates, or from a free fall onto a hard surface. Thus, a removable cartridge 100 (FIG. 1) may be a ruggedized container that houses a hard disk drive. The removable cartridge is then connected to a larger computer system or network via a carrier installed in a desktop or server system. The carrier typically includes interface and control circuits to operably connect the hard disk drive inserted into the carrier to the motherboard of the host desktop or server system. Either the original removable cartridge is re-inserted or a different removable cartridge can be inserted back into the carrier installed in the desktop or server. This insertion/removal cycle may occur several times throughout the work day.

In certain situations, the removable cartridge, and associated hard disc drive, is utilized for archiving data. The archived data is sometimes also stored in a manner conducive to preserving free space on the removable hard disk drive. Such data archiving mechanisms will typically employ a host application to facilitate transfer of data to and from the removable hard drive. This scenario can potentially be problematic, however, in that the host application, and related installation package, may not be available at a later date. Another possible scenario could be when it is desired to access the archived data using a host that employs a differing operating system than that of the original host and host application that archived the data.

### SUMMARY

The present invention, in particular embodiments, provides methods, apparatuses and systems directed to a removable cartridge which has a data storage device, such as a hard drive, that contains a data archive application and a loader or installer. Implementations of the invention allow a removable data storage cartridge to appear as a self-contained archive and backup solution. In one implementation, the data storage device contains platform-independent archive data, and one or more differing platform-dependent archive applications. When the removable cartridge is connected to a host with no installed archive application, an archive application on the removable cartridge, corresponding to the host operating system, may be installed. Archive data is then translated to a format compatible with the host operating system and provided to the host.

The following embodiments and aspects thereof are described and illustrated in conjunction with systems, apparatuses and methods which are meant to be exemplary and illustrative, not limiting in scope. In various embodiments, one or more of the above-described problems have been reduced or eliminated. In addition to the aspects and embodiments described above, further aspects and embodiments will become apparent by reference to the drawings and by study of the following descriptions.

### BRIEF DESCRIPTION OF THE DRAWINGS

Example embodiments are illustrated in referenced figures of the drawings. It is intended that the embodiments and figures disclosed herein are to be considered illustrative rather than limiting.

FIG. 1 illustrates an embodiment of a removable cartridge containing a hard disk drive data storage system, in accordance with an example embodiment;

FIGS. 2A and 2B illustrate an embodiment of a cartridge carrier, in accordance with an example embodiment;

FIG. 3 illustrates insertion of the removable cartridge into the cartridge carrier, in accordance with an example embodiment;

FIG. 4 illustrates a hard disc drive contained in the removable cartridge, in accordance with an example embodiment;

FIG. 5 illustrates a disassembled removable cartridge, in accordance with an example embodiment;

FIG. 6 illustrates retrieval of operating system-independent archive data on a hard disc drive of a removable cartridge, in accordance with an example embodiment; and

FIG. 7 is a flowchart diagram illustrating a method for conditionally installing an archive application, stored on a hard disc drive of the removable cartridge, to a host system.

### DETAILED DESCRIPTION

The following embodiments and aspects thereof are described and illustrated in conjunction with systems, apparatuses and methods which are meant to be illustrative, not limiting in scope.

The present invention, in particular embodiments, provides methods, apparatuses and systems directed to a removable cartridge which has a data storage device, such as a hard drive, that contains a data archive application and a loader or installer. In one implementation, the data storage device contains platform-independent archive data, and one or more differing platform-dependent archive applications. When the removable cartridge is connected to a host with no installed archive application, an archive application on the removable cartridge, corresponding to the host operating system, may be installed. Archive data is then translated to a format compatible with the host operating system and provided to the host.

One implementation may include storing archive data in an operating system-specific format, on a data storage system of the removable cartridge, and translating the archive data to other operating system formats when a host with a different operating system is encountered. In various implementations, the data storage system may include, but not limited to, a hard disc drive, a solid state device (SSD), flash memory and the like. In another implementation, the data storage system of the removable cartridge contains archive data in an operating system-specific format and a corresponding operating system host archive application. Hosts of a differing operating system may then access the archive data by running a virtual operating system corresponding to the archive data format.

Other implementations provide for selectively installing the archive application. For example, if the host already has an installed archive application, an installation is typically not required. If the archive application, on the data storage system of the removable cartridge, was once previously installed, as determined via an entry in a removable cartridge log file, and the removable cartridge is password-protected, successful authentication will be required to install the archive application. Password-protection may also be employed if the host already has an installed archive application.

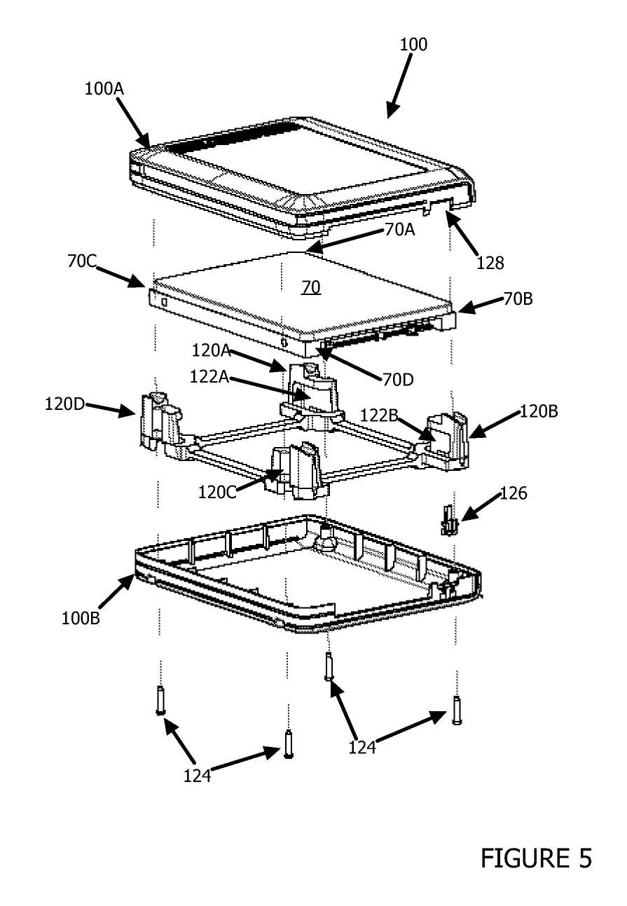

For didactic purposes, an embodiment of the present invention operates in connection with the removable cartridge system illustrated in FIGS. 1, 2A, 2B and 3. The present invention, however, can operate in connection with a vast array of removable media systems. FIG. 1 illustrates an embodiment of a removable cartridge. The removable cartridge 100 may be any shape or size necessary for its use. The removable cartridge 100 may have notches 102 and orientation tab channel 104 to assist in the positioning of the removable cartridge 100 in the carrier and to allow a user to visually ascertain that the removable cartridge 100 is properly inserted into the carrier. Removable cartridge 100 further includes a top part 100A and a bottom part 100B, both of which are further illustrated via FIG. 5.

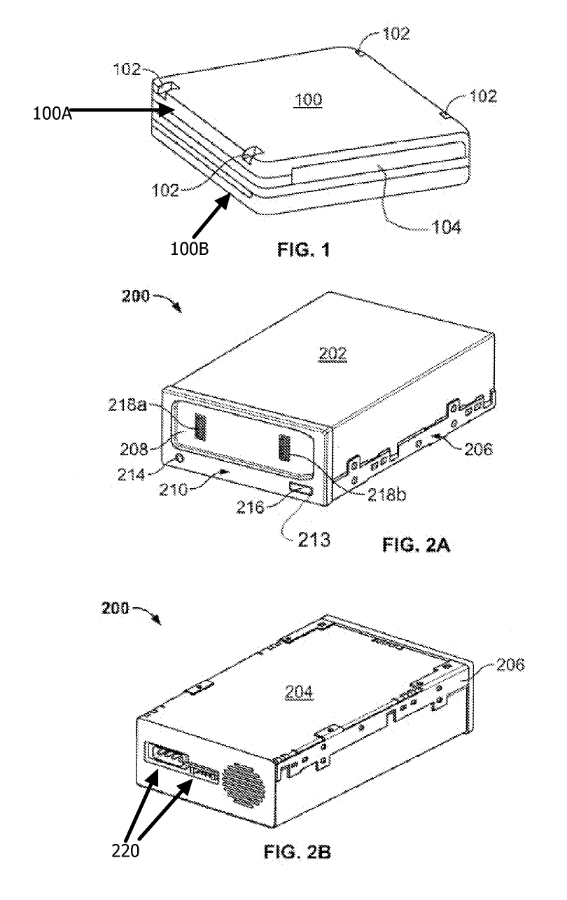

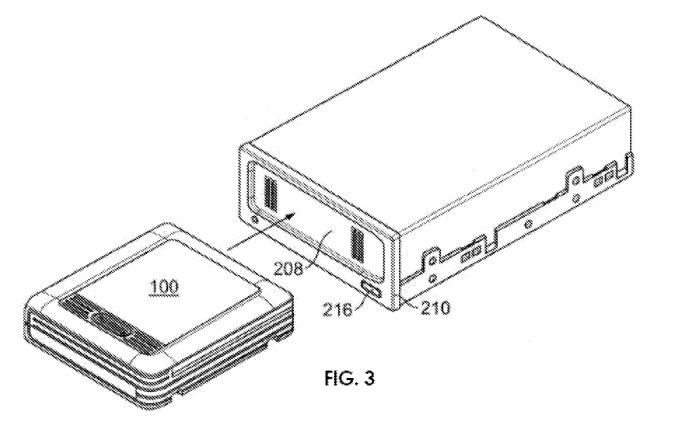

FIGS. 2A and 2B are diagrams of a cartridge carrier according to one implementation of the present invention. The cartridge carrier 200, in one implementation, is a docking mechanism into which the removable cartridge 100 is inserted. As discussed in more detail below, the cartridge carrier 200 provides the interconnection between the motherboard of the host computing device and the target hard disk drive 70 contained in the removable cartridge 100. As mentioned previously, however, data storage systems other than a hard disc drive may be utilized in conjunction with the present invention. The cartridge carrier 200 may have a top cover 202, a bottom cover 204, and a base 206 thereby forming an enclosure. The base 206 connects the bottom cover 204 and the top cover 202 and is positioned within the enclosure. The cartridge carrier 200 may be designed to fit into a 3.5 inch form factor for installation into a bay of a desktop or server box. The carrier 200 may be made of any dimensions necessary, but may have an outside dimension of about between 90-110 mm width, 30-50 mm height, and about 130-190 mm length. As FIG. 2B illustrates, the cartridge carrier 200 includes a connector assembly 220 to allow for a physical connection between the host computing device and the cartridge carrier electronics discussed below. Of course, other implementations are possible. For example, the carrier may be a stand-alone unit, such as a dock that is external from a host computing system.

The cartridge carrier 200, in one implementation, has an opening assembly 210 to provide access to the enclosure and to guide the removable cartridge 100 into the carrier. The opening assembly 210 may have a door 208, a light pipe opening 214, and an eject button 216. The opening assembly 210 may be contoured to the profile of the carrier 200, and may be larger in height and width than the carrier 200. The opening assembly 210 may be removably connected to the carrier 200 by any means such as snap fit, friction fit, attached with an adhesive, and the like. The door 208 may be designed to be spring closed when a removable cartridge 100 is not present and may contain a plurality of risers 218a, 218b to contact the removable cartridge 100. The ridges reduce wear marks on the door and the removable cartridge 100. U.S. application Ser. Nos. 10/940,111 and 10/962,484, provide further details of the mechanical configuration and operation of the cartridge carrier system, such as the physical connection of the interface connectors between the data storage unit of the removable cartridge 100, upon insertion, to the corresponding interface connectors of the carrier.

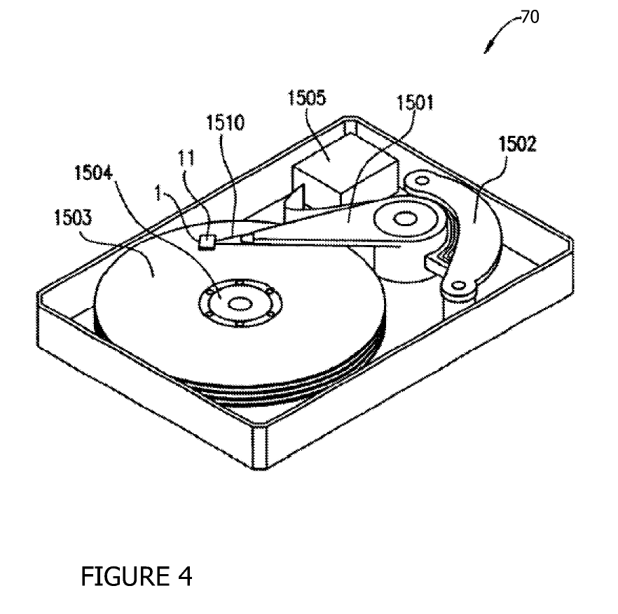

FIG. 4 illustrates a hard disc drive 70 contained in the removable cartridge 100, in accordance with an example embodiment. The hard disc drive 70 includes a head actuator 1510 including a head slider 11 provided with a magnetic head 1, a head carriage 1501 for carrying the head actuator 1510, a linear or rotational voice coil motor 1502 for moving the magnetic head 1 via the head actuator 1510, a spindle motor 1504 for rotating one or more discs or platters 1503, and control logic 1505.

The spindle motor 1504 rotates the disc 1503 at a prescribed speed. The voice coil motor 1502 moves the head actuator 1510 including the head slider 11 provided with the magnetic head 1 across a surface of the disc 1503 in a radial direction of the disc 1503, so that the magnetic head 1 can access a prescribed data track on the disc 1503. The head 1 then records information to or reproduces information from the disc 1503.

The head slider 11 for carrying the magnetic head 1 is, for example, an air bearing slider. In this case, the head slider 11 contacts the surface of the disc 1503 when the hard disc drive 70 starts and stops operating. During the recording or reproduction of the hard disc drive 70, the head slider 11 is held above the disc 1503 by the air bearing formed between the disc 1503 and the head slider 11.

Also for didactic purposes, an embodiment of the present invention operates in connection with various operating system disk formats and data translation schemes between differing operating systems. Additionally, a hard disc drive, such as hard disc drive 70 in removable cartridge 100 and other data storage systems, may contain multiple partitions each hosting a differing disk format. These various concepts will now be described.

Starting with partitions, disk partitioning is the creation of logical divisions upon a hard disk drive or other data storage systems that allows one to apply operating system-specific logical formatting. Partitioning a hard disc drive can make it behave like multiple, independent non-partitioned hard drives for most practical purposes; the main difference with separate hard disks is that partitions of the same hard disk share their hardware. Partitioning a hard disk drive defines specific areas (the partitions) within the disk. A partition may constitute an entire logical drive or it may form part of a larger virtual drive which could span over several partitions and hard disks. Within a partition, a file system may be created for the storage of files, or a partition may be used for other purposes, such as swap space for those operating systems that support “swap partitions.”

Turning to file systems, in general, a file system is a method for storing and organizing computer files and the data they contain to make it easy to find and access them. File systems may use a data storage device such as a hard disk drive or CD-ROM and involve maintaining the physical location of the files, they might provide access to data on a file server by acting as clients for a network protocol, or they may be virtual and exist only as an access method for virtual data. A file system may also be described as a set of abstract data types that are implemented for the storage, hierarchical organization, manipulation, navigation, access, and retrieval of data.

Some example file systems operating systems include FAT (‘File Allocation Table’ whose variants include FAT12, FAT16, FAT 32) and NTFS (New Technology File System)—all utilized by Microsoft Windows®. Linux typically utilizes ext (Extended File System) and ext2(Second extended file system). FFS (Fast File System), USF (Unix File System) and UFS2 may be used by BSD (Berkeley Software Distribution or sometimes referred to as Berkeley Unix). Apple® systems will typically make use of HFS (Hierarchical File System) and HFS Plus.

Another type of file system is Universal Disk Format (UDF) which is typically used for storing files on optical media and is readable and writable by most major file systems. Some operating systems may also employ dedicated translators to convert data in one file system format to another format. One example of such a translator is Samba which is utilized by Unix to talk to Microsoft Windows® file systems.

The present invention may also be used in conjunction with virtual machines (VM). A VM is a software implementation of a machine (computer) that executes programs like a real machine. More specifically, a VM may be used to simulate one particular operating system or perhaps application within an actual machine running the same or different operating system.

Other concepts used by or in conjunction with the present invention include AutoRun, or sometimes termed AutoPlay, which is the ability of many computer operating systems to automatically take some action upon the insertion of removable media such as a CD-ROM, DVD-ROM, flash media or a removable cartridge containing a hard disc drive. AutoRun is generally intended as a convenience feature for software distributed on a disc such that an installer can be started upon insertion of the disc. An example AutoRun installer is the Microsoft® Installer which sometimes referred to as MSI which is also the file extension used for that installer.

As mentioned previously, the present invention provides for a removable cartridge, and associated data storage system which contains operating system-independent archive data, which may be in a UDF format. Also included are archive applications, archive application loaders and translators for one or more operating systems as defined by their corresponding file systems. When a removable cartridge is connected to a host, via a cartridge carrier, an appropriate archive application loader will be sensed by the host and the archive application may be loaded on the host. The operating system-independent archive date is then translated to the operating system of the host for delivery and re-translated back as necessary.

In one implementation, the archive applications for the various operating systems are pre-installed on a hard disc drive of the removable cartridge. In another implementation, the archive applications are installed onto the hard disc drive of the removable cartridge when an archive application on a CD is initially installed on a host, as part of the initial installation process.

Speaking in general on the archive application on a host in relation to archived data on the hard disc drive of the removable cartridge, the archived data is generally de-duplication-optimized in that records of incremental changes to data is recorded at the removable cartridge. This technique advantageously reduces a required amount of storage for the archive data. The operation system-independent archive data typically is located in one partition, of the hard disc drive, while an archive application, archive application loader and translator, for each supported operating system, are stored in other partitions.

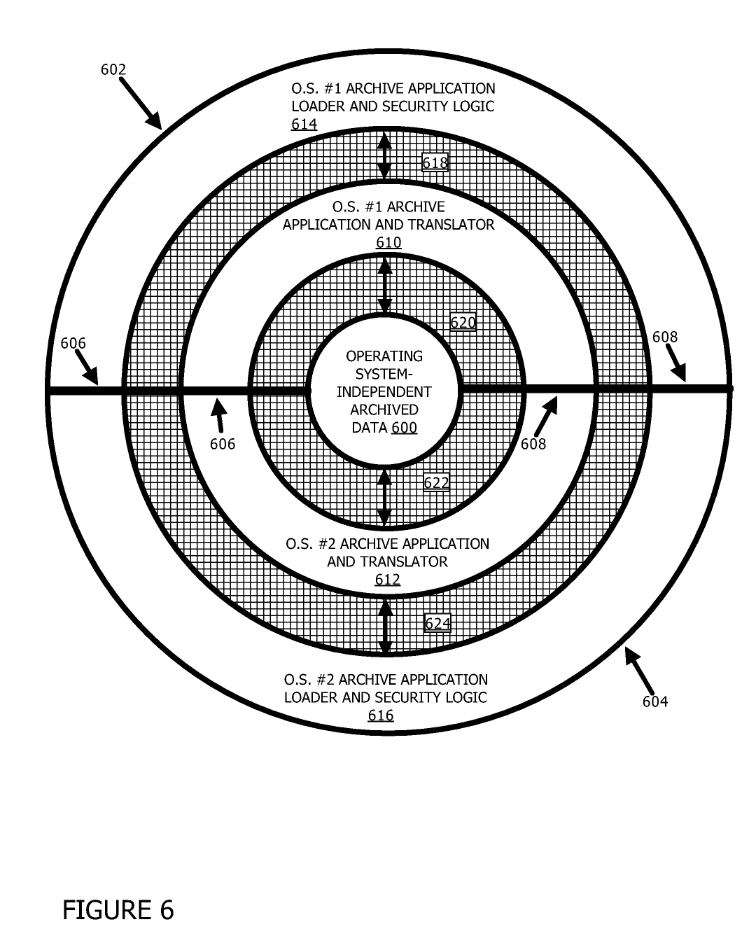

Hard disc drive partitioning, of the present invention, is shown in FIG. 6 which illustrates retrieval of operating system-independent archive data on a hard disc drive of a removable cartridge, in accordance with an example embodiment. In one partition 600 is the operating system-independent archived data. In two other partitions 602 and 604, as delineated by lines 606 and 608, are operating system #1 and #2's archive applications, translators and archive application loaders. Also included is security logic which determines when an archive application may be loaded onto a host which will be discussed subsequently. It should be understood that while just two operating system partitions (602, 604) are depicted in FIG. 6, additional, or just one operating system partition may be present on the hard disc drive of the removable cartridge.

Logically, FIG. 6 represents data translation between partition 600, which contains the operating system-independent archive data and the other partitions (602, 604). The archive data in partition 600 may be translated by a translator in section 610 or 612, of partitions 602 and 604 respectively, which is then sent to a host (not shown). Also included in FIG. 6 are sections 614 and 616 which initially determine whether to install an archive application onto a host. Sections 618, 620, 622 and 624 illustrate data flow paths within a partition (602, 604) and between partition 600 and partitions 602, 604.

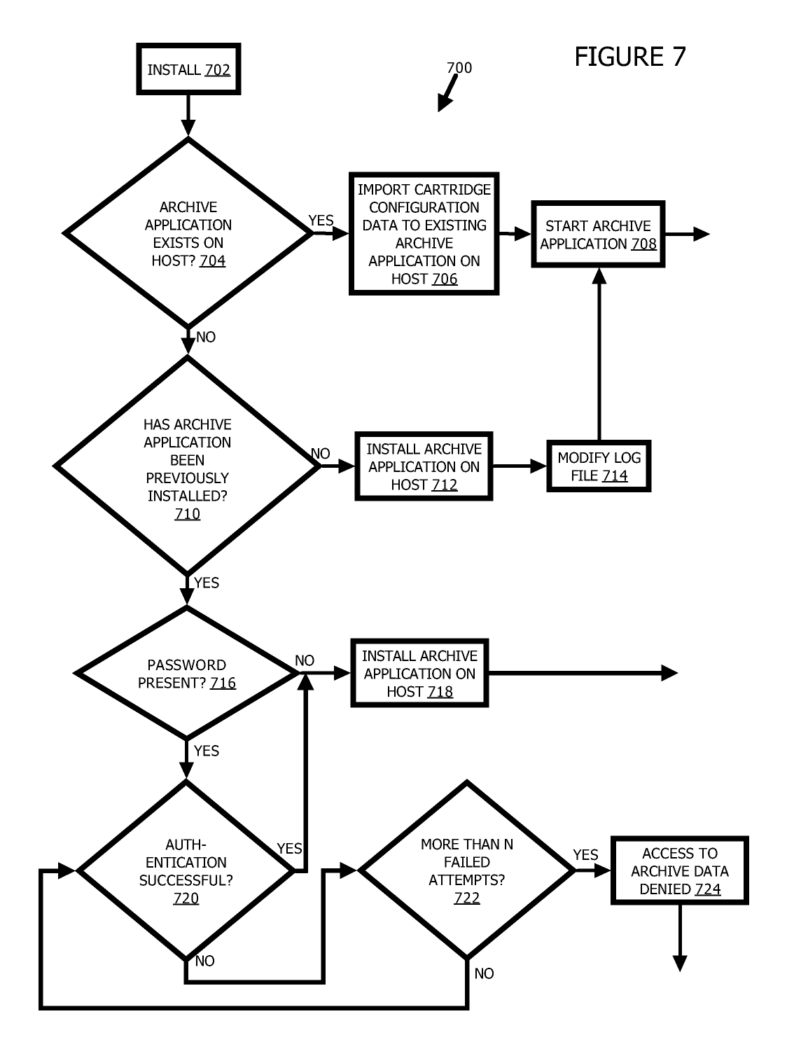

FIG. 7 illustrates a method 700 for control logic, such as control logic of FIG. 4, to install an archive application on a host. When a removable cartridge is inserted into a carrier connected to a host, an archive application installation process 702 begins. Control logic determines (704) if an archive application is already on the host. If yes, control logic imports (706) the removable cartridge configuration information and archive data to the archive application and the archive application launches (708).

If an archive application is not on the host (704) then control logic determines if an archive application contained on the removable cartridge was previously installed (710). This is accomplished by reviewing a log file on the removable cartridge. This check is done to safeguard the archive data in case a password was set for the removable cartridge and the removable cartridge is being connected to a new host.

If the archive application, on the removable cartridge was not previously installed (710), that may be indicative that it may be a first installation of the archive application from the removable cartridge to a host. Therefore, the archive application installs on the host (712), control logic updates the log file (714) and the archive application starts (708).

If the archive application was previously installed (710), control logic determines if the removable cartridge is password protected (716). If no, the archive application installs on the host (718). In one implementation, the password is stored in an applet on the hard disc drive of the removable cartridge.

If a password is present (716) and authentication is successful (720), then the archive application installs on the host (718). In one implementation, if authentication is not successful (720), a number of additional authentications attempts may be made until a threshold number of unsuccessful authentications (722) has been reached. At that point, control logic denies access to the archive data (724).

In one implementation, a password may also be prompted for between operations 704 and 706 wherein an archive application is already installed on a host.

In one implementation, if a more up-to-date version of the archive application is present on either of the host or the removable cartridge, then the most up-to-date version is sent to either device.

In yet another implementation, the archived data may be stored on a hard disc drive of the removable cartridge in an operating system-specific format. In such a configuration, a corresponding archive application and archive loader would reside in a same partition as the archive data. Other partitions would then use their translators to convert the archive data.

In another implementation, a hard disc drive of a removable cartridge may just have a partition for operating system-specific archive data, an archive application and an archive application loader. In this implementation, hosts of a differing operating system may still be able to access the archive data by utilizing a virtual machine of a type that emulates the operating system of the archived data.

While a number of exemplary aspects and embodiments have been discussed above, those of skill in the art will recognize certain modifications, permutations, additions and sub-combinations thereof. For example, the present invention may be used to authenticate other storage media, such as flash memory or other solid-state storage devices. Furthermore, the media authentication processes described herein can be incorporated into the storage driver protocol stack installed on, and implemented by, a host computing system. Accordingly, it is therefore intended that the following appended claims and claims hereafter introduced are interpreted to include all such modifications, permutations, additions and sub-combinations as are within their true spirit and scope.

What is claimed is:

1. A removable media cartridge, comprising:
a cartridge shell;
a data storage module housed within the cartridge shell; and
wherein the data storage module contains an archive application and an archive application loader.

2. The removable media cartridge as recited in claim 1 wherein the application loader is operative to be detected by a host operating system and install the archive application on the host operating system.

3. The removable media cartridge as recited in claim 1 wherein the archive application and the archive application loader are located on a first partition, of the data storage module, formatted for a first operating system.

4. The removable media cartridge as recited in claim 3 wherein the data storage module includes one or more other partitions each containing an archive application and an archive application loader and wherein each partition, on the data storage module, is formatted for differing operating systems.

5. The removable media cartridge as recited in claim 1 wherein the data storage module is a hard disc drive module, housed within the cartridge shell, the hard disc module comprising an interface, one or more platters, one or more read/write heads controlled by an actuator assembly and control logic.

6. A removable media cartridge, comprising:
a cartridge shell;
a data storage module housed within the cartridge shell; and
wherein the data storage module contains operating system-independent archived data located in a first partition;
wherein the data storage module contains two or more additional partitions each containing an archive application and an archive application loader wherein at least two of the two or more additional partitions are formatted for differing operating systems;
wherein the archive application includes a translator operable to bi-directionally convert the operating system-independent archived data to and from a format compatible with a corresponding operating system of the archive application; and
wherein the archive application loader is operative to be detected by a corresponding host operating system and install the archive application on the corresponding host operating system.

7. The removable media cartridge as recited in claim 6 wherein the data storage module is a hard disc drive module, housed within the cartridge shell, the hard disc module comprising an interface, one or more platters, one or more read/write heads controlled by an actuator assembly and control logic.

8. The removable media cartridge as recited in claim 6 further comprising control logic operable to selectively install the archive application.

9. The removable media cartridge as recited in claim 8 wherein the control logic is further operable to selectively install the archive application based on successful cartridge password authentication.

10. The removable media cartridge as recited in claim 9 wherein cartridge password authentication includes a maximum number of authentication attempts for successful entry of a cartridge password.

11. A removable media cartridge, comprising:
a cartridge shell;
a data storage module housed within the cartridge shell;
wherein the data storage module contains, in a first partition, operating system-specific archived data, an archive application and an archive application loader;
wherein the data storage module contains one or more additional partitions each containing an archive application and an archive application loader wherein at least one of the one or more additional partitions are formatted for a different operating system than that of the first partition;
wherein the archive application of the one or more additional partitions each include a translator operable to bi-directionally convert the operating system-specific archived data to and from a format compatible with an operating system located in a partition of the one or more additional partitions; and
wherein application loaders, located in the first and one or more additional partitions, are each operable to be detected by a corresponding host operating system and install the archive application on the corresponding host operating system.

12. The removable media cartridge as recited in claim 11 wherein the data storage module is a hard disc drive module, housed within the cartridge shell, the hard disc module comprising an interface, one or more platters, one or more read/write heads controlled by an actuator assembly and control logic.

13. The removable media cartridge as recited in claim 11 further comprising control logic operable to selectively install the archive application.

14. The removable media cartridge as recited in claim 13 wherein the control logic is further operable to selectively install the archive application based on successful cartridge password authentication.

15. The removable media cartridge as recited in claim 14 wherein cartridge password authentication includes a maximum number of authentication attempts for successful entry of a cartridge password.

16. A removable media cartridge, comprising:
a cartridge shell;
a data storage module housed within the cartridge shell;
wherein the hard disc drive module contains operating system-specific archived data;
wherein the data storage module contains an archive application and an archive application loader; and
wherein the application loader is operative to be detected by a corresponding host operating system and install the archive application on the corresponding host operating system.

17. The removable media cartridge as recited in claim 16 wherein the data storage module is a hard disc drive module, housed within the cartridge shell, the hard disc module comprising an interface, one or more platters, one or more read/write heads controlled by an actuator assembly and control logic.

18. The removable media cartridge as recited in claim 16 wherein the corresponding host operating system is a virtual corresponding host operating system on a host.

19. The removable media cartridge as recited in claim 16 further comprising control logic operable to selectively install the archive application.

20. The removable media cartridge as recited in claim 19 wherein the control logic is further operable to selectively install the archive application based on successful cartridge password authentication.

21. The removable media cartridge as recited in claim 20 wherein cartridge password authentication includes a maximum number of authentication attempts for successful entry of a cartridge password.
